(19) United States
(12) Patent Application Publication
(10) Pub. No.: US 2011/0081210 A1
(43) Pub. Date: Apr. 7, 2011

(54) CUTTING INSERT, CUTTING TOOL AND CUTTING METHOD USING THE SAME

(76) Inventor: Takuya Ishida, Shiga (JP)

(21) Appl. No.: 12/994,608

(22) PCT Filed: Sep. 28, 2009
(86) PCT No.: PCT/JP2009/066784

§ 371 Date: Nov. 24, 2010

(30) Foreign Application Priority Data
Sep. 29, 2008 (JP) 2008-251200

(51) Int. Cl. B23C 5/20; B23C 5/06; B23B 27/16

(52) U.S. Cl. 407/42; 407/113; 409/131

(57) ABSTRACT

A cutting insert is provided with an upper surface, a lower surface, side surfaces for interconnecting the upper surface and the lower surface, cutting edges located at the intersections between the upper surface and the side surfaces, and grooves located in the side surfaces, extending from the upper surface toward the lower surface, and dividing the cutting edges. Each of the grooves is provided with a first edge and a second edge which are located at the edges of the groove in the width direction thereof and extending from the upper surface toward the lower surface. In a side view, the first edge has a first separated section located on the upper surface side and, as the first edge extends toward the lower surface, separated away from a reference line which passes through the midpoint of the groove in the width direction thereof and is substantially perpendicular to the lower surface. Also, in the side view, the second edge has a second separated section located on the upper surface side and separated away from the reference line as the second edge extends toward the lower surface.

### TECHNICAL FIELD

The present invention relates to a cutting insert used for working a metal or the like, a cutting tool and a cutting method using them.

### BACKGROUND ART

Conventionally, in terms of an excellence of economical efficiency, there has been used a throw away type cutting tool in which a cutting insert having a cutting edge is installed to a holder in use.

As a cutting insert used in the cutting tool, for example, in patent document 1, there is disclosed a cutting insert provided with a cutting edge which is positioned at an intersection of an upper surface and a side surface, and a groove portion which reaches the upper surface in such a manner as to divide the cutting edge. Further, the groove portion is provided so as to be inclined in one direction with respect to a virtual line which is orthogonal to the cutting edge when viewed from the side. Accordingly, a contact between the groove portion and a workpiece is suppressed, and a smooth cutting can be achieved, by installing the cutting insert to the holder in such a manner that the cutting edge has a positive axial rake, and the groove portion becomes approximately in parallel to a rotation locus of the cutting tool.

However, since the groove portion is inclined only in one direction, the cutting insert mentioned above is effective for suppressing the contact between the groove portion and the workpiece, with respect to the cutting tool in which a rotating direction at a time of cutting is a given one direction; however, in the case of being used in a cutting tool in which the rotating direction is a reverse direction, there is a case that the groove portion comes into contact with the workpiece.

### PRIOR ART PUBLICATION

### Patent Publication

Patent Publication 1: Japanese Unexamined Patent Publication No. 09-57519

### SUMMARY OF THE INVENTION

An object of the present invention is to provide a cutting insert which can be used in both cutting tools in which rotating directions at a time of cutting are different from each other and are excellent in a general purpose property and an economical efficiency.

### MEANS FOR SOLVING THE PROBLEM

A cutting insert in accordance with the present invention is provided with an upper surface, a lower surface, a side surface connecting the upper surface to the lower surface, a cutting edge positioned at an intersection of the upper surface and the side surface, and a groove portion positioned on the side surface, extending from the upper surface toward the lower surface and dividing the cutting edge. The groove portion has a first edge portion and a second edge portion which are positioned at an edge portion in a width direction of the groove portion and extend from the upper surface toward the lower surface. The first edge portion has a first separation portion which is positioned close to the upper surface side, and is further away from a reference line passing through a middle point in a width direction of the groove portion and being approximately vertical to the lower surface as it comes close to the lower surface, in the side view. On the other hand, the second edge portion has a second separation portion which is positioned on the upper surface side, and is further away from the reference line as it comes close to the lower surface, in the side view.

A cutting tool in accordance with the present invention is provided with a holder, and the cutting insert installed to a front end of the holder.

Further, a cutting method of a workpiece in accordance with the present invention includes a step of rotating the cutting tool, a step of bringing into contact with the cutting tool in a state in which the cutting tool is rotated, and a step of separating the cutting tool from the workpiece.

### EFFECT OF THE INVENTION

In accordance with the cutting insert of the present invention, it is possible to inhibit the wall surface of the groove portion from coming into contact with the workpiece, even in the case of using any of two kinds of cutting tools in which the rotating directions at a time of cutting are different from each other.

### BRIEF DESCRIPTION OF THE DRAWINGS

FIG. 1 is a general perspective view of a cutting insert 1 in accordance with a first embodiment of the present invention;

FIG. 2(a) is a plan view of a cutting insert 1 in FIG. 1, and FIG. 2(b) is a side elevational view;

FIG. 3 is an enlarged view of a substantial part of FIG. 2(a);

FIG. 4 is a general perspective view of a cutting insert 1′ in accordance with a second embodiment of the present invention;

FIG. 5(a) is a plan view of the insert 1′ in FIG. 4, and FIG. 5(b) is a side elevational view;

FIG. 6 is a general perspective view of a cutting tool 10 in accordance with an embodiment of the present invention; and

FIG. 7(a), FIG. 7(b), FIG. 7(c), and FIG. 7(d) is a process chart illustrating a cutting method of a workpiece in accordance with an embodiment of the present invention.

### MODE FOR CARRYING OUT THE INVENTION

### Cutting Insert

### First Embodiment

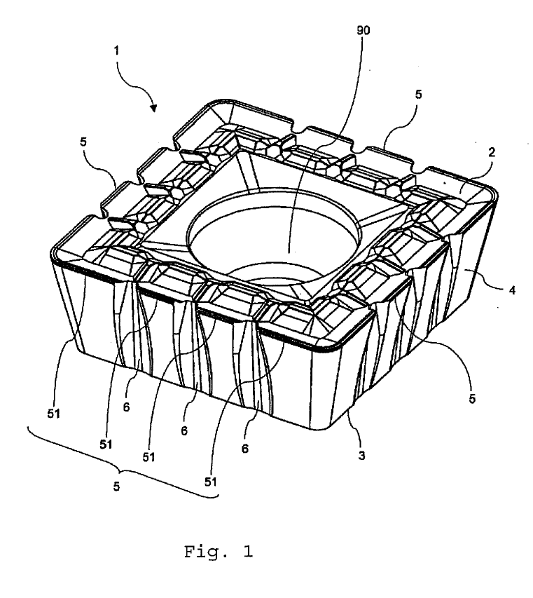

A description will be given in detail of a cutting insert (hereinafter, refer to as insert) in accordance with a first embodiment of the present invention with reference to FIGS. 1 to 3.

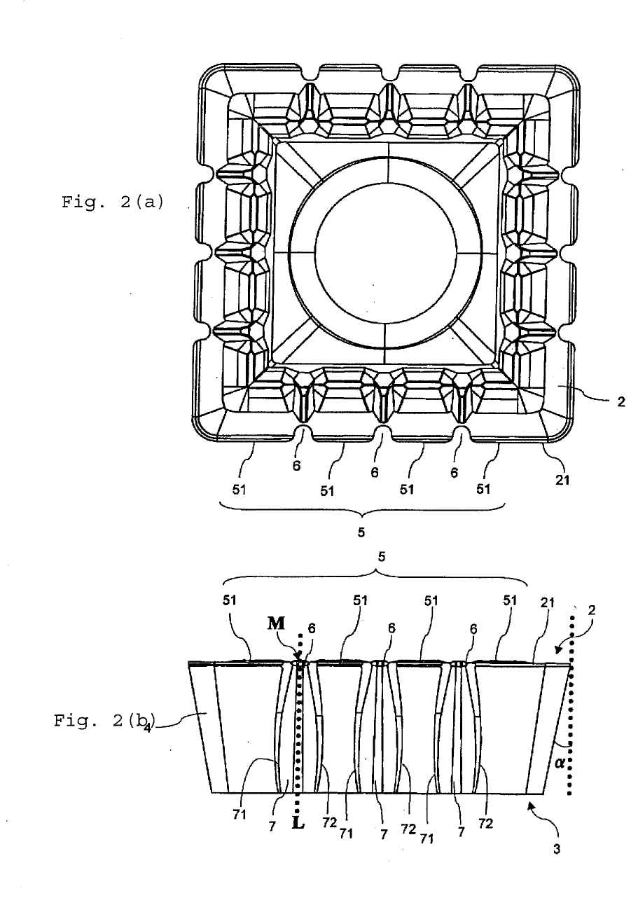

As shown in FIGS. 1 and 2, an insert 1 has an upper surface 2, a lower surface 3, and a side surface 4 connecting the upper surface 2 and the lower surface 3. The upper surface 2 has a first side 21, and is formed as an approximately polygonal shape. In the present embodiment, as shown in FIG. 2(a), the upper surface 2 is formed as an approximately square shape.

The insert 1 has a cutting edge 5 and a groove portion 6. The cutting edge 5 is provided in an intersection of the upper surface 2 and the side surface 4 so as to extend along the first side 21. The groove portion 6 is provided on the side surface 4 so as to extend from the upper surface 2 toward the lower surface 3, in such a manner as to divide the cutting edge 5.

An area heading for an inner side from the cutting edge 5 of the upper surface 2 serves as a rake face. Further, an area heading for a lower surface from the cutting edge 5 of the side surface 4 serves as a clearance. In this case, in the present embodiment, the side surface 4 is inclined in such a manner as to be positioned inward as it heads for the lower surface 2, as shown in FIG. 2(b). In other words, the insert 1 is a so-called positive type insert in which a positive clearance angle α is applied to the side surface 4 serving as the clearance. In terms of easily having a positive clearance angle at a time of installing the insert 1 to the holder and keeping a strength of the insert, the clearance angle α is preferably set between 5 degree and 30 degree.

In the present embodiment, the upper surface 2 is formed as the approximately square shape as mentioned above, and has four sides, and the cutting edges 5 are respectively provided along these four sides. Accordingly, the insert 1 is a so-called four-corner type insert having four cutting edges 5.

Further, in the present embodiment, the cutting edge 5 is divided into four small cutting edges 51 by three groove portions 6. Since the cutting edge 5 is divided, it is possible to reduce a cutting resistance of the cutting edge applied at a time of cutting. Note that the groove portions 6 are all formed as the same shape in FIG. 2(b).

As shown in FIG. 2(b), a wall surface 7 of the groove portion 6 has a first edge portion 71 and a second edge portion 72 which extend toward the lower surface 3 from the upper surface 2, in the side view. Each of the first edge portion 71 and the second edge portion 72 is a crossing edge portion between the wall surface 7 of the groove portion 6 and the side surface 3. For example, the first edge portion 71 and the second edge portion 72 may be an area in a range from a crossing ridge between the wall surface 7 of the groove portion 6 and the side surface 3 to about 20% of a depth of the groove portion 6 along the wall surface 7.

As shown in FIG. 2(b), the first edge portion 71 is positioned on one side with respect to a reference line L. Further, the second edge portion 72 is positioned on the other side with respect to the reference line L. The reference line L is a line which passes through a middle point M and is vertical to the lower surface 3, on the assumption that the middle point M is a middle point of the wall surface 7 of the groove portion 6 in a direction extending along the first side 21 (a width direction). Note that the middle point M means a middle point on an upper end of the wall surface 7 of the groove portion 6. In other words, the reference line L is positioned between the first edge portion 71 and the second edge portion 72.

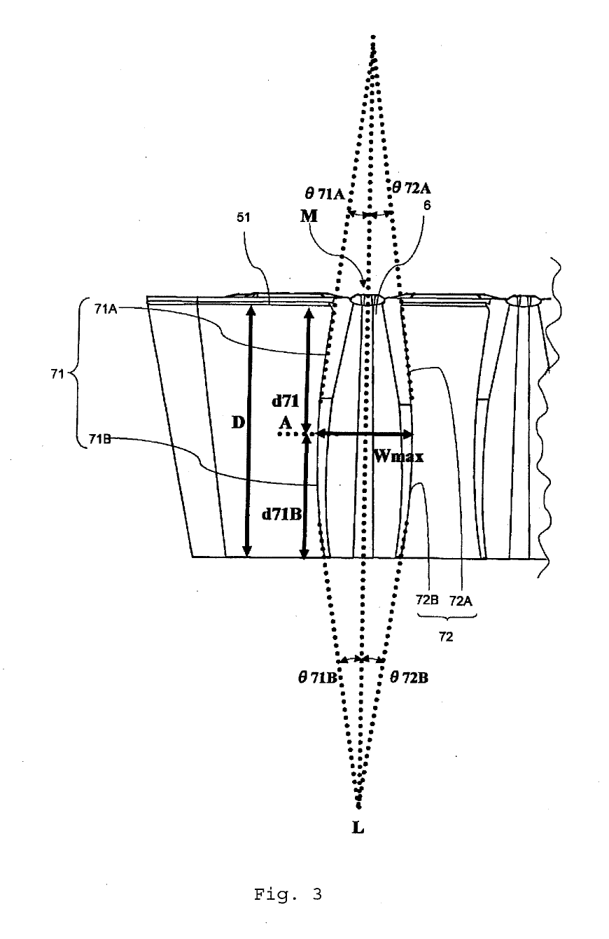

The first edge portion 71 has a separation portion 71A which is provided in such a manner as to come away from the reference line L as it heads for the lower surface 3 from the upper surface 2, in the upper surface 2 side in the side view, as shown in FIG. 3. On the other hand, the second edge portion 72 also has a separation portion 72A which is provided in such a manner as to come away from the reference line L as it heads for the lower surface 3 from the upper surface 2, in the upper surface 2 side. That is, an area in which a width of the groove portion 6 is increased from the upper surface 2 toward the lower surface 3 is provided in the upper surface 2 side of the groove portion 6, in the side view.

In accordance with the structure mentioned above, even in the case of being used in any of two kinds of cutting tools in which the rotating directions at a time of cutting are different, it is possible to inhibit the groove portion 6 from coming into contact with the workpiece at a time of cutting. Accordingly, one kind of insert 1 can be used for two kinds of cutting tools, with the result that it is excellent in a general purpose property and an economical efficiency. In addition, the insert 1 mentioned above is excellent in management and it is possible to achieve an improvement of a working efficiency at a time of replacing the insert 1.

It is preferable that the separation portion 71A of the first edge portion 71 and the separation portion 72A of the second edge portion 72 are symmetrical with respect to the reference line L as shown in FIG. 3. Accordingly, it is possible to improve a strength of the insert 1 as well as inhibiting the groove portion 6 from coming into contact with the workpiece.

In the present embodiment, each of the separation portion 71A and the separation portion 72A is formed as a linear shape in the side view. In accordance with the structure mentioned above, since the cutting insert can be arranged in such a manner that a longitudinal direction of the groove portion becomes approximately in parallel to a rotation locus of the tool while the cutting edge has the positive axial rake, in any of the cutting tools (the holders) in which the rotating directions are different, it is possible to more securely inhibit the wall surface 7 of the groove portion 6 from coming into contact with the workpiece.

In the present embodiment, as shown in FIG. 3, both the first edge portion 71 and the second edge portion 72 have close portions B (71B and 72B) in a closer side to the lower surface 3 than the separation portion A. The close portions B are respectively provided in such a manner as to come close to the reference line L as they come close to the lower surface 3, in the side view. In other words, an area in which the width of the groove portion 6 is reduced from the upper surface 2 toward the lower surface 3 is provided in the lower surface 3 side of the groove portion 6, in the side view.

In accordance with the structure mentioned above, since a volume decrease of the insert caused by the provision of the groove portion is suppressed on the lower surface 3 side, it is possible to keep high a strength of the lower surface 3 side of the side surface 4. Accordingly, the insert 1 is stably fixed to the holder, and a working precision of the workpiece is improved. In this case, as shown in FIGS. 2(b) and 3, each of the close portion 71B and the close portion 72B is formed as a curved shape.

As mentioned above, the first edge portion 71 has the separation portion 71A positioned on the upper surface 2 side, and the close portion 71B positioned on the lower surface 3 side, and in the present embodiment, the separation portion 71A and the close portion 713 are connected. Further, in the second edge portion 72, the separation portion 72A and the close portion 72B are connected.

Further, as shown in FIG. 3, an angle of gradient of the separation portion 71A with respect to the reference line L is set to θ71A, and an angle of gradient of the close portion 71B with respect to the reference line is set to θ71B. At this time, a relationship θ71A>θ71B is established. Further, an angle of gradient of the separation portion 72A with respect to the reference line L is set to θ72A, and an angle of gradient of the close portion 72B with respect to the reference line is set to θ72B. At this time, a relationship θ72A>θ72B is established. It is possible to more securely inhibit the wall surface 7 of the groove portion 6 from coming into contact with the workpiece, by enlarging the angle of gradient of the separation portion as mentioned above.

θ71A and θ72A can be determined, for example, by the following manner. For example, in the case that the separation portion 71A is formed as a linear shape in the side view, θ71A can be determined by an angle formed by a virtual extension line of the separation portion 71A and the reference line L, as shown in FIG. 3. On the other hand, in the case that the separation portion 71A is formed as a curved shape in the side view, it can be determined by an angle formed by a tangential line on an upper end and the reference line L. It is preferable that θ71A and θ72A are set between 10 degree and 30 degree in terms of retaining the strength of the insert. In the present embodiment, since the separation portion 71A and the separation portion 72A are symmetrical with respect to the reference line L, a relationship θ71A≅θ72A is established, and specifically a relationship θ71A≅θ72A=12 degree is established.

On the other hand, θ71B and θ72B can be determined in the same manner as the θ71A mentioned above, as shown in FIG. 3. It is preferable to set θ71B and θ728 between 5 degree and 25 degree in terms of retaining the strength of the insert. In the present embodiment, since both the close portion 71B of the first edge portion and the close portion 72B of the second edge portion are symmetrical with respect to the reference line L, a relationship θ71B≅θ72B is established, and specifically a relationship θ71B≅θ72B=10 degree is established.

Further, in the present embodiment, as shown in FIG. 3, a width W of the groove portion 6 is maximized at a position of a middle point between the upper surface 2 and the lower surface 3, in the side view. In other words, on the assumption that a distance between the upper surface 2 and the lower surface 3 is set to a distance D, a maximum value Wmax of the width W of the groove portion 6 corresponds to a width in a middle point of the distance D.

In accordance with the structure mentioned above, it is possible to combine an effect of inhibiting the wall surface 7 of the groove portion 6 from coming into contact with the workpiece, and an effect of retaining the strength of the side surface 4.

### Second Embodiment

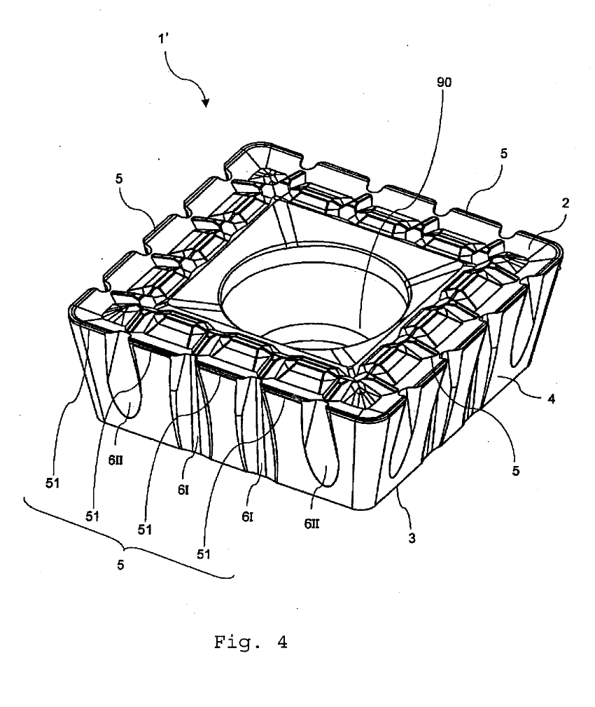

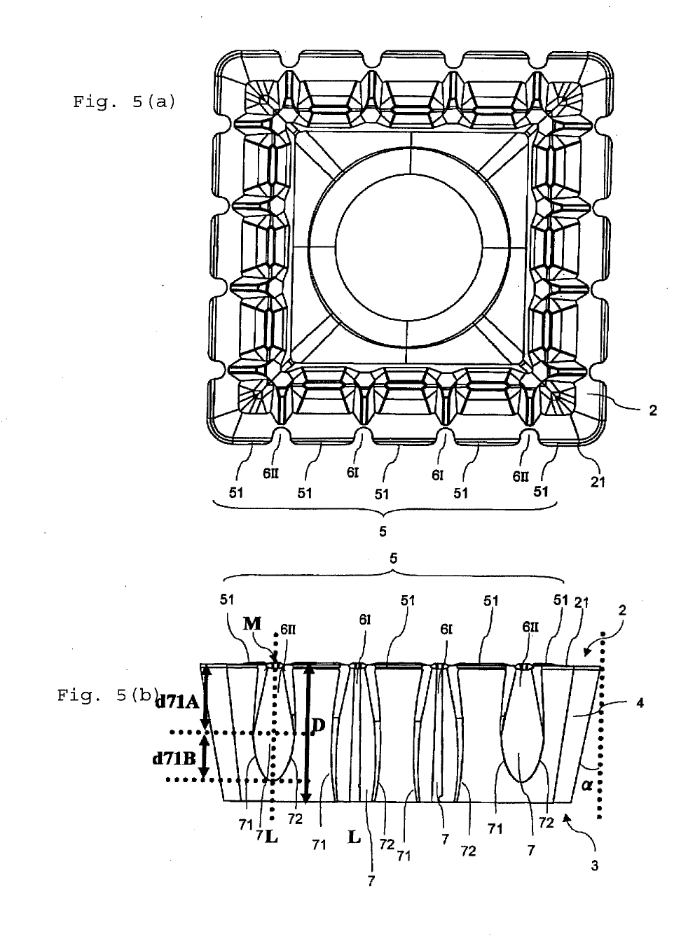

A description will be in detail given below of an insert 1′ in accordance with a second embodiment of the insert of the present invention with reference to FIGS. 4 and 5. Note that the same reference numerals are attached to the same structures as those of the insert 1 in the first embodiment, and a description thereof will be omitted.

As shown in FIGS. 4 and 5, the insert 1′ of the second embodiment is different from the insert 1 of the first embodiment in the shape of the groove portion 6 and in the number of the groove portions 6 provided on one cutting edge 5.

In other words, in the present embodiment, four groove portions 6 are provided with respect to one cutting edge 5. Accordingly, the cutting edge 5 is divided into five small cutting edges 51. A cutting tool 10 mentioned below can be obtained by combining the insert 1 and the insert 1′ having different arrangements of the groove portion 6 in the cutting edge 5 so as to install to the holder, as mentioned above.

In the present embodiment, as shown in FIG. 5(b), of four groove portions 6 two groove portions 6I positioned on an inner side is different from two groove portions 6II positioned on an outer side in shape.

The groove portion 6I is formed as approximately the same shape as that of the groove portion 6 in the insert 1 in accordance with the first embodiment mentioned above. The groove portion 6I is provided on the side surface 4 in such a manner as to reach the lower surface 3. On the other hand, the groove portion 6II does not reach the lower surface 3. In other words, a lower end of the groove portion 6II is positioned on the side surface 4. Since the groove portion does not reach the lower surface in the groove portion 6II, the groove portion 6II can retain the strength of the insert side surface 4 in comparison with the groove portion 6I. As mentioned above, the groove portion 6II can combine an effect of reducing a cutting resistance, and an effect of keeping high the strength of the side surface 4.

In this case, in the groove portion 6II, it is preferable that the width W of the groove portion 6 is maximized at the middle point of the distance D between the upper surface 2 and the lower surface 3, in the same manner as the insert 1 in accordance with the first embodiment mentioned above.

Accordingly, a dimension in a direction which is approximately vertical to the lower surface 3 of the separation portion 71A of the first edge portion in the side view is set to d71A, and a dimension which is approximately vertical to the lower surface 3 of the close portion 71B of the first edge portion is set to d71B. In this case, the groove portion 6I has a relationship d71A≅d71B, while the groove portion 6II has a relationship d71A>d71B. Further, in the same manner, in the close portion 72, the groove portion 61 has a relationship d72A≅d72B, while the groove portion 6II has a relationship d72A>d72B.

The inserts in accordance with two embodiments are exemplified above, though the present invention is not limited to them. For example, the upper surface may be formed as the other shapes such as a rhomboid shape, a triangular shape and the like. Further, the first edge portion 71 and the second edge portion 72 may be structured such as to be asymmetrical with respect to the reference line L. Further, at least one of the first edge portion and the second edge portion may have an area which is provided so as to be approximately in parallel to the reference line L, between the separation portion A and the close portion B.

<Cutting Tool>

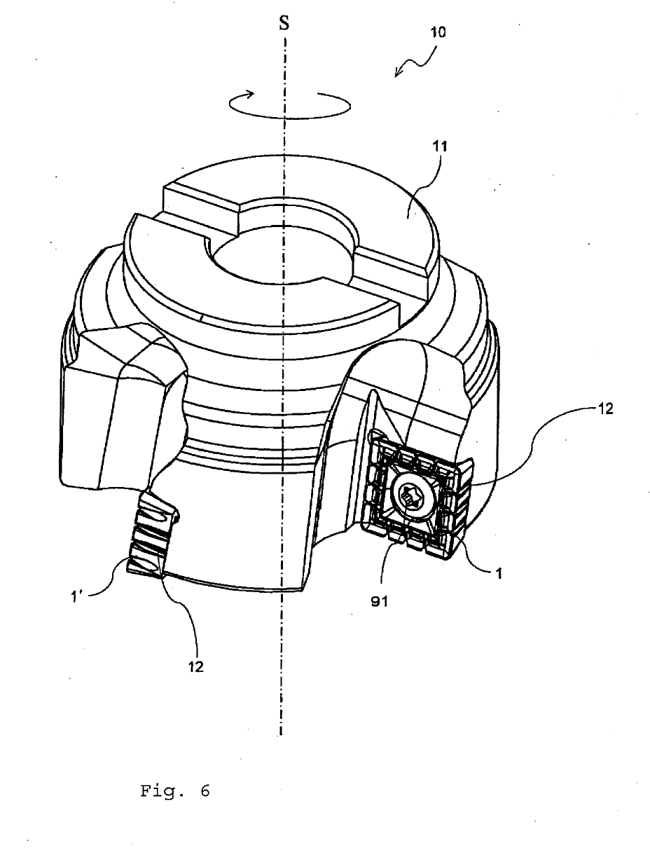

The cutting tool 10 in accordance with the present embodiment has a holder 11, and the insert 1 and the insert 1′ mentioned above, as shown in FIG. 6. The insert 1 and the insert 1′ are installed to a front end of the holder 11. Specifically, the insert 1 and the insert 1′ are installed to the holder 11 by inserting a fixing screw 91 to a through hole 90 of the inset 1, and engaging a front end of the fixing screw 91 to a thread hole (not shown) formed in an insert pocket 12 of the holder 11. At this time, the insert 1 and the insert 1′ are both installed to the holder 11 in such a manner that the cutting edge 5 protrudes from the front end surface of the holder 11.

Further, in the present embodiment, the insert 1 and the insert 1′ are alternately installed two by two in a peripheral direction. At this time, the insert 1 and the insert 1′ are installed to the holder 11 in such a manner that the lower surface 3 is inclined with respect to an axis of the holder 11. That is, the insert 1 and the insert 1′ are installed to the holder 11 while having an axial rake.

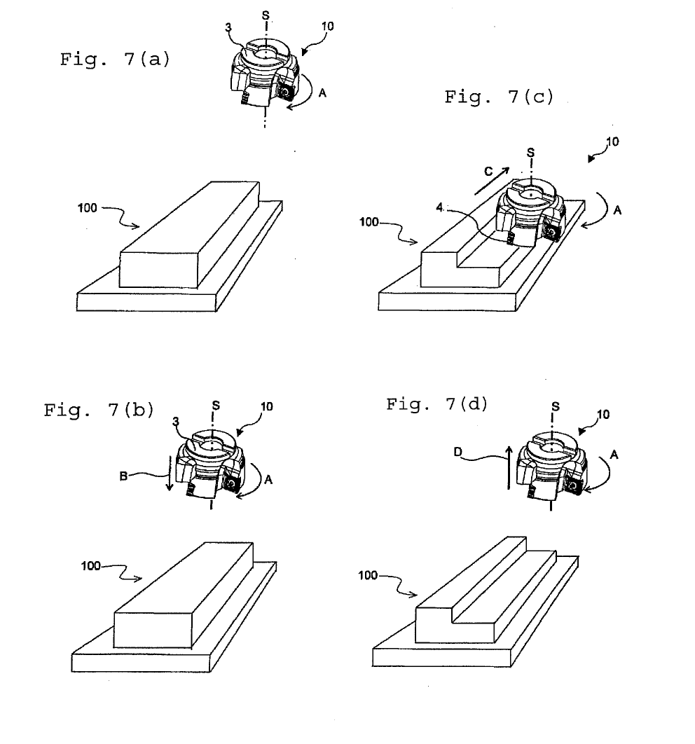

In the present embodiment, the cutting tool 11 is used by being rotated in a clockwise direction at a time of cutting, as shown in FIG. 7 mentioned below. Since the cutting tool 11 mentioned above has the insert 1 and the insert 1′ mentioned above, it is possible to inhibit the wall surface 7 of the groove portion 6 from coming into contact with the workpiece. This enables a reduction in cutting resistance at a time of cutting, thereby allowing the cutting work under a high load cutting condition. As a result, an improvement of a working efficiency can be achieved.

There is exemplified the structure which is installed to the holder by the fixing screw in the cutting tool of the embodiment in accordance with the present invention, however, the structure is not limited to this, but may be made such that the insert is installed to the holder by the other clamp mechanism.

Further, in the present embodiment, a face mill cutter is exemplified, however, the structure is not limited to this, but it is possible to employ a side cutter having cutting edges on both side surfaces, a plunge cutter, a cutting tool capable of working a corner cutting and the like.

<Cutting Method>

A cutting method of the workpiece in accordance with the present embodiment is provided with the following steps (a) to (d).

(a) a step of rotating the cutting tool 10 in a direction of an arrow A around the axis S of the holder 11, as shown in FIG. 7(a).

(b) a step of moving the cutting tool 10 close to a workpiece 100 by moving the cutting tool 10 in a direction of an arrow B, as shown in FIG. 7(b).

(c) a step of cutting a surface of the workpiece 100 by bringing the cutting edge 5 of the insert 2 into contact with the surface of the workpiece 100, and moving the cutting tool 10 in a direction of an arrow C, as shown in FIG. 7(c).

(d) a step of keeping the cutting tool 10 away from the workpiece 100 by moving the cutting tool 10 in a direction of an arrow D, as shown in FIG. 7(d).

Accordingly, as mentioned above, since the workpiece 100 is worked by using the cutting tool 10 having the high working precision, it is possible to obtain a worked material having a high finished surface precision.

In this case, in the step (b) mentioned above, it is sufficient to relatively approximate the cutting tool 10 to the workpiece 100, and for example, the workpiece 100 may be moved close to the cutting tool 10. Likewise, in the step (d) mentioned above, it is sufficient to relatively keep away the workpiece 100 from the cutting tool 10, for example, the workpiece 100 may be kept away from the cutting tool 10. In the case of carrying over the cutting work, it is sufficient to repeat the step of bringing the cutting edge 5 of the insert 1 into contact with the different positions of the workpiece 100 while keeping a state in which the cutting tool 10 is rotated. When the used cutting edge wears, an unused cutting edge is used by rotating the insert 1 at 90 degree around a center axis of the through hole 90.

The embodiments in accordance with the present invention are exemplified above; however, it goes without saying that the present invention is not limited to the embodiments, but may be optionally structured without departing from the purpose of the invention.

1. A cutting insert, comprising:
an upper surface;
a lower surface;
a side surface connecting the upper surface and the lower surface;
a cutting edge located at an intersection of the upper surface and the side surface; and
a groove portion located on the side surface, the groove portion extending from the upper surface toward the lower surface and dividing the cutting edge,
wherein the groove portion comprises a first edge portion and a second edge portion, which are located on an edge portion in a width direction of the groove portion and extend from the upper surface toward the lower surface,
wherein the first edge portion comprises a first separation portion which is located closer to the upper surface side and is further away from a reference line as approaching the lower surface in the side view, the reference line passing through a middle point in a width direction of the groove portion and being approximately vertical to the lower surface, and
wherein the second edge portion comprises a second separation portion which is located closer to the upper surface side and is further away from the reference line as approaching the lower surface in the side view.

2. The cutting insert according to claim 1, wherein the first separation portion and the second separation portion are symmetrical with respect to the reference line.

3. The cutting insert according to claim 1, wherein at least one of the first separation portion and the second separation portion has a linear shape in the side view.

4. The cutting insert according to claim 1, wherein the first edge portion further comprises a first close portion, the first close portion being located below the first separation portion and being closer to the reference line as approaching the lower surface in the side view.

5. The cutting insert according to claim 4, wherein the second edge portion further comprises a second close portion, the second close portion being located below the second separation portion and being closer to the reference line as approaching the lower surface in the side view.

6. The cutting insert according to claim 4, wherein at least one of the first close portion and the second close portion has a curved shape in the side view.

7. The cutting insert according to claim 3, wherein an angle of gradient of the first separation portion with respect to the reference line is larger than an angle of gradient of the first close portion with respect to the reference line.

8. The cutting insert according to any one of claim 3, wherein an angle of gradient of the second separation portion with respect to the reference line is larger than an angle of grad; ent of the second close portion with respect to the reference line.

9. The cutting insert according to any one of claim 3, wherein a width of the groove portion is maximum at a middle point between the upper surface and the lower surface in the side view.

10. A cutting tool, comprising:
a holder; and
a cutting insert which is installed to a front end of the holder, the cutting insert comprising:
an upper surface;
a lower surface;
a side surface connecting the upper surface and the lower surface;
a cutting edge located at an intersection of the upper surface and the side surface; and
a groove portion located on the side surface, the groove portion extending from the upper surface toward the lower surface and dividing the cutting edge,
wherein the groove portion comprises a first edge portion and a second edge portion, which are located on an edge portion in a width direction of the groove portion and extend from the upper surface toward the lower surface,
wherein the first edge portion comprises a first separation portion which is located closer to the upper surface side and is further away from a reference line as approaching the lower surface in the side view, the reference line passing through a middle point in a width direction of the groove portion and being approximately vertical to the lower surface, and
wherein the second edge portion comprises a second separation portion which is located closer to the upper surface side and is further away from the reference line as approaching the lower surface in the side view.

11. The cutting tool according to claim 10, wherein the first separation portion and the second separation portion are symmetrical with respect to the reference line.

12. The cutting tool according to claim 10, wherein at least one of the first separation portion and the second separation portion has a linear shape in the side view.

13. The cutting tool according to claim 10, wherein the first edge portion further comprises a first close portion, the first close portion being located below the first separation portion and being closer to the reference line as approaching the lower surface in the side view.

14. The cutting tool according to claim 13, wherein the second edge portion further comprises a second close portion, the second close portion being located below the second separation portion and being closer to the reference line as approaching the lower surface in the side view.

15. The cutting tool according to claim 13, wherein at least one of the first close portion and the second close portion has a curved shape in the side view.

16. The cutting tool according to claim 12, wherein an angle of gradient of the first separation portion with respect to the reference line is larger than an angle of gradient of the first close portion with respect to the reference line.

17. The cutting tool according to claim 12, wherein an angle of gradient of the second separation portion with respect to the reference line is larger than an angle of gradient of the second close portion with respect to the reference line.

18. The cutting tool according to claim 12, wherein a width of the groove portion is maximum at a middle point between the upper surface and the lower surface in the side view.

19. A cutting method of a workpiece, comprising:
rotating a cutting tool;
bringing a cutting edge of the cutting tool into contact with the workpiece, in a state in which the cutting tool is rotated; and
separating the cutting tool relatively from the workpiece;
wherein the cutting tool comprises:
a holder; and
a cutting insert which is installed to a front end of the holder,
the cutting insert comprising:
an upper surface;
a lower surface;
a side surface connecting the upper surface and the lower surface;
a cutting edge located at an intersection of the upper surface and the side surface; and
a groove portion located on the side surface, the groove portion extending from the upper surface toward the lower surface and dividing the cutting edge,
wherein the groove portion comprises a first edge portion and a second edge portion, which are located on an edge portion in a width direction of the groove portion and extend from the upper surface toward the lower surface,
wherein the first edge portion comprises a first separation portion which is located closer to the upper surface side and is further away from a reference line as approaching the lower surface in the side view, the reference line passing through a middle point in a width direction of the groove portion and being approximately vertical to the lower surface, and
wherein the second edge portion comprises a second separation portion which is located closer to the upper surface side and is further away from the reference line as approaching the lower surface in the side view.
